(19) United States
(12) Patent Application Publication
(10) Pub. No.: US 2025/0178131 A1
(43) Pub. Date: Jun. 5, 2025

(54) METHOD FOR PROVIDING A WELDED STRUCTURE GENERATED IN AN AT LEAST PARTLY COMPUTER-AIDED MANNER, IN PARTICULAR FOR INDUSTRIAL TRANSMISSIONS, AND CORRESPONDINGLY PRODUCED WELDED STRUCTURE, AND COMPUTER PROGRAM PRODUCT, AND USE

(71) Applicant: Flender Industriegetriebe GmbH, 09322 Penig (DE)

(72) Inventors: Gerd Hauser, Penig (DE); THERESA GAELINGS, Penig (DE); DAVID SEEGERS, Penig (DE); JENS KIEBEL, Penig (DE); ANDREAS ANGENENDT, Penig (DE); KAREN POSER, Penig (DE); ROBERT LUTZKE, Penig (DE); ROBERT KUPFER, Penig (DE); ROBERT NAGEL, Penig (DE); ANDREAS FIEDLER, Penig (DE); DANIEL HÜTTNER, Penig (DE); FREDERIK GROSS-HARDT, Penig (DE); JÖRG BUHL, Penig (DE); FRANZ SCHMEINK, Penig (DE); BERNHARD HÜBERS, Penig (DE)

(73) Assignee: Flender Industriegetriebe GmbH, 09322 Penig (DE)

(21) Appl. No.: 18/842,962

(22) PCT Filed: Feb. 1, 2023
(86) PCT No.: PCT/EP2023/052407

§ 371 Date: Aug. 30, 2024

(30) Foreign Application Priority Data
Mar. 2, 2022 (EP) 22159736.2

(51) Int. Cl. B23K 31/02

(52) U.S. Cl. CPC B23K 31/02

(57) ABSTRACT

In a method for providing a welded construction generated in an at least partially computer-assisted manner, especially for industrial transmission, an individual construction-specific input parameter of at least part of the welded structure is defined manually and/or with computer assistance from build size parameter, terminal fit parameter, and build shape parameter. A database includes a partly variable construction kit in which at least two standardized parts are recorded, with one of the at least two standardized parts being selected in a computer-assisted manner to form the welded construction. The welded construction is generated in a computer-assisted manner using the selected one of the at least two standardized parts and taking into account of the individual construction-specific input parameter.

### TECHNICAL FIELD

The present invention relates to a method of providing a welded construction generated in an at least partly computer-assisted manner, especially for industrial transmissions. The present invention further relates to a correspondingly created welded construction or to a welded housing based thereon. The present invention further relates to a corresponding computer program product and the corresponding uses. In particular, the invention relates to the at least partly computer-assisted and at least partly automated creation of modularized or modularly constructed welded (housing) constructions, especially in segment design. In particular, the invention relates to apparatuses and methods according to the preamble of the respective independent claims.

### BACKGROUND OF THE INVENTION

(Industrial) transmission manufacture involves a large amount of material expenditure, especially also of steel, for example for transmission housings (for example cast and/or welded constructions). The production of the materials to be expended is comparatively energy-intensive; the material itself is also quite valuable in many applications, i.e. costly. The use of material is found to be more intensive in cast constructions than in welded constructions in many cases, and so welded constructions are the preferred target in view of high demands on material and energy savings. But in this regard too, there is an interest in further energy and material savings, especially without having to disproportionately increase expenditure in respect of construction adjustments or the like. In other words, there is a need for a standardizable measure, at least in its main features, for material- and energy-optimized design of transmission housings and similar comparatively complex constructions.

There follows a description of an illustrative application: industrial transmissions are conventionally designed as cast housings for moderate to large runs; any add-on components and other accessories are also designed for this scale. Small runs or special requirements sometimes also require housing variants manufactured by welding (especially since a casting method only becomes economically viable over and above comparatively large runs). The construction is designed for the highest load case, since scalability is not typically envisaged. The construction especially proceeds from large-area solid sheets, flame-cut parts and fins. Especially for the creation of the outlines required in the production of single parts, however, a comparatively high energy expenditure is required. In this context, it has hitherto regrettably also been necessary to accept a comparatively high level of offcut material, which not least also causes high emission of CO2. There is therefore an interest in measures for optimization of the situation and the associated drawbacks.

Publication U.S. Pat. No. 5,552,995 A describes a computer-assisted construction process in which the component to be produced and a tool to be provided for the purpose and the corresponding production process can be designed depending on one another.

### DESCRIPTION OF THE INVENTION

Proceeding from this situation, it is an object of the present invention to be able to simplify, especially to be able to optimize in a computer-assisted manner, the construction of comparatively complex industrial devices, especially transmission housings, especially welded or cast constructions, with regard to minimized material use. Another object in the case of such apparatuses/constructions, especially in the case of cast or welded housing constructions, even in the case of individually application-specific demands, is to enable at least partial standardization and to recommend, in an at least partly automated computer-assisted manner, the use of standard components in the creation of the construction, especially also proceeding from cast constructions for creation of a welded construction usable as an alternative to a cast construction, which may be based at least partly and preferably in maximum proportions on standardized and material-/energy input-optimized parts.

The object of the invention is achieved by the features of the independent main claims. Advantageous configurations are specified in the dependent claims. Where technically possible, the teaching of the respective dependent claims may be combined as desired with the teaching of the further main and dependent claims.

In particular, the object is accordingly achieved by a method of providing a welded construction generated in an at least partly computer-assisted manner, especially a welded housing construction for industrial transmissions, wherein at least one individual/individualizable construction-specific input parameter of at least part of the welded construction from the following group is defined manually or with computer assistance: build size parameter (length, width, height, especially as outer dimension parameter), terminal fit parameter, build shape parameter; wherein at least partly computer-assisted definition of the welded construction is achieved by reference to a database with a partly variable construction kit recorded therein, in which at least two standardized parts are recorded, of which at least one standardized part is chosen in a computer-assisted manner to form the welded construction, wherein the welded construction is generated in a computer-assisted manner using the at least one selected standardized part and taking account of the at least one individual construction-specific input parameter. This enables considerable assistance of the construction efficiency in the linking of construction steps on the one hand and of production/manufacturing processes on the other hand.

In this respect, the present invention also affords a kind of construction guideline or construction manual by which, in a simple manner, a welded construction optimized with regard to material use can be generated, especially proceeding from hitherto conventionally utilized cast constructions or other such integral solid constructions (conversion of conventional constructions not achievable by welding to welded constructions optimized with regard to material use). The starting point for the implementation of the present invention may be chosen individually in the specific case; the starting point may be optimization of a conventional cast construction, or the starting point may be selection of a welded construction that can/is to be further optimized. The invention is specificized hereinafter, especially with regard to (industrial) transmission housings (welded or cast constructions).

The parts to be utilized for the overall construction may, for example, form a cavity surrounded by multiple side walls of the welded construction (for example side wall of a transmission housing) in which a transmission may be accommodated, where at least one hub strip marks a bushing of a shaft through at least one of the side walls.

The invention also relates to a construction concept that makes it possible to implement different degrees/depths of digitalization for the construction process, especially depending on the catalogue of parts provided or entered (database of usable variable or standardized (component) parts). In other words, it is envisaged in particular that a respective constructor, with the aid of a partly variable toolkit, in an at least partly computer-assisted manner, for example relating to a single side wall of an industrial transmission housing, can ascertain construction options or suggestions. The invention accordingly also relates to a procedure or a method of construction that enables or at least facilitates conversion of various user-/application-specific demands, especially with regard to external dimensions and terminal fits of the (housing) construction to be created, in an at least partly automated manner to an at least partly standardized welded construction. It is also possible here to take account of measurement data from an old transmission system (especially with reference to a replacement transmission region) and reference data from at least one database for comparable applications, especially in order to be able to optimize the design additionally to the primary requirement in the respective individual case (especially also for avoidance of disadvantageously material-intensive oversizing or disadvantageous overdimensioning).

According to the invention, the welded construction or individual parts of the construction are subdivided into standardized parts and variable parts, especially into segments and modules (sub-grouping) that are assigned to a partly variable construction kit system (see also FIG. 3). This not least also facilitates very substantial standardization with regard to a maximum number of parts in the construction.

A construction kit according to the present disclosure is especially understood to mean a dataset having a multitude of construction elements or components that are of limited availability, for example, in a manufacturing process or can be provided for a particular construction task. A partly variable construction kit according to the present disclosure especially means a construction kit having at least two alternatively usable parts and/or having at least one (component) part which is variable with regard to at least one parameter, where the construction kit additionally also comprises standardized parts, such that a selection of parts can also be made depending on whether/which standardized parts are available or usable. According to the present disclosure, a digitally integratable construction kit especially means a construction kit that at least supports the selection of parts by computer-assisted calculation models (for example also with involvement of digital tools based on artificial intelligence algorithms) and/or linkage between construction process and manufacturing process, especially by taking account of the capabilities of predefinable manufacturing lines.

The partly variable construction kit system may be generated or administered/further developed in particular by the following processes or steps: classification of (transmission) configuration (see also step S2 according to details further down); request/comparison of existing data and/or performance data (step S4, S4); assignment/allocation of reference parts and variable parts (step S6); collecting/taking account of measurement data from at least one existing/reference transmission (step S10).

Each of these processes can be configured individually in accordance with the manufacturing steps desired or chosen in the individual case, especially/for example with the following references: production of individual (standard) parts/segments (see also step or process S200 according to details below); welding production of variable modules (step or process S300); connection/assembly of at least two modules (step or process S400); completion of production of the welded housing (step or process S500).

Two examples of the setup and utilization of the construction kit are given hereinafter, firstly a relatively simple example relating to a hole pattern: in the case of standardized manufacture, normally what are called 150% models are used, especially in order to be able to implement a maximum number of applications without reworking; however, this conversely also means that, in many applications, there are too many holes/bores in the housing, which then, as experience has shown, regrettably have to be closed again in the course of assembly. In this respect, the result is in fact extra work in two respects; first more material removal work than needed is performed, and subsequently manual reworking is necessary for the excess bores (removal/closure). However, this procedure that has to date caused additional work, based on an invariable library of parts with recorded conventional construction drawings, was barely avoidable to date, unless each individual component was matched manually to each order, even with regard to the hole pattern.

Now a rather more complex example, relating in particular to material availability and hence also the manufacturing process that follows the creation of construction; in the country of production, for example, particular sheet thicknesses are unavailable, the result of which is, for example, that a hub strip cannot be produced without using a 200 mm-thick sheet for burnoff. It is possible to take account of this fact (in particular on a day-to-day basis) in the context of the partly variable construction kit described here, especially in terms of runtime-based generation (input parameter and/or optimization parameter), especially in that the system is referred to a different segment. The latter in the present example consists, for example, of further subsegments and can also, for example, form a further module; these subsegments in this example are available or producible in a material-/energy-efficient manner in the country of production and can be procured in a simpler manner than the 200 mm-thick sheet. While a burning process is necessary in the case of a 200 mm sheet, merely an additional welding process is required in the production of the model generated with computer assistance from subsegments. Even substitution of materials (within defined/predefinable limits, especially in an individualizable manner for construction kit or the respective application) can require a possibly only time-limited adaptation of the process (reaction to current market situation or supply options), especially of a welding process, and such a circumstance can also be reflected or taken into account in the construction kit of the invention. For example, a parameter study in the course of optimization iterations, for example in the event of a reduction in load in a specific application, can lead in a simple manner to a construction that enables much easier execution of welding, for example with the same sheet thickness. In this way, numerous and manifold synergy effects are generatable.

According to the invention, it is especially also possible to achieve the following advantages: saving of material by stress-matched design and/or reduction of offcuts; matching to individual demands owing to the partly variable construction kit, especially since it is frequently possible to convert desired variants to a standard; digital constancy/consistency of development, construction and production operations; simplified long-term product care (especially also due to a digital copy), substantial or complete omission of analogous documentation.

The present invention may be/may have been implemented for different types of welded constructions. Welded housing constructions are referred to specifically hereinafter, especially in the case of comparatively complex industrial transmissions, although the corresponding disclosure may also be applicable to other kinds of constructions; in this respect, the term “welded housing constructions” implicitly also refers generally to a welded construction created/creatable in accordance with the invention (or else just a subgroup thereof, in the sense of a partial solution for the overall construction, for example just one side wall assembly), and vice versa, provided that there is no emphasis of a particular meaning in the respective context. Welded (housing) construction in the narrower sense should be considered here to mean the construction as such (construction data, construction plans), i.e. not yet the welded housing (to be) produced on that basis. The degree/scope of an individual manner of implementation of the present invention depending on the application, in conjunction with specific manufacturing lines/processes, may be fixed specifically by the person skilled in the art in the individual case, as will be elucidated in detail hereinafter using individual examples/references.

The concept of the invention is elucidated here in each case with illustrative reference to particular types of welded constructions, especially with regard to analysis or segmentation (for design purposes) of welded housing constructions. Where welded constructions are discussed in general terms, the expression may also encompass, for example, at least one of the following types of welded construction or assemblies, especially in each case configured as an assembly of an industrial transmission: motor lantern, standard cylinder (especially with a disk- or ring-shaped flange supported thereon), brake console, swing arm, gear wheel (welded, especially diameter in the range from 1 to 5 meters), cone with flange, cylinder with flange aligned in the radial plane and supported by means of fins. An illustrative spectrum of possible applications is also shown in the figures.

The welded (housing) construction is generated here in a computer-assisted manner both on the basis of the at least one selected standardized part and on the basis of at least one variable part recorded in the partly variable construction kit (in each case selected from a group of variably alternatively usable parts), especially taking account of at least one individual terminal fit parameter and/or at least one individual construction size parameter. This also facilitates efficient handling of the computer-assisted construction models in the case of constructions with a high number of variants that permit numerous alternatives.

Elucidated hereinafter are further advantageous aspects of the invention claimed, and descriptions are given further down of preferred modified working examples of the invention. Elucidations, especially with regard to advantages and definitions of features, are fundamentally descriptive and preferred but nonlimiting examples. If any elucidation is to be understood as limiting, this will be mentioned explicitly.

In one working example, the welded housing construction is/has been divided into predefined/predefinable segments and into modules or the standardized and/or variable parts recorded in the partly variable construction kit is/have been divided into predefined/predefinable segments and modules, wherein, for the welded housing construction, at least one segment and at least one module are selected, wherein the respective segment and the respective module preferably each comprise at least part of the welded housing construction, and especially each comprise multiple parts connected/connectable to one another, and wherein the computer-assisted definition/generation of the welded housing construction involves reference to the database with a partly variable construction kit in which the segments and modules are recorded and from which segments and modules suitable for the welded housing construction are selected in a computer-assisted manner, wherein the welded housing construction is generated from this construction kit in the case of at least partial standardization by inclusion of at least one of the predefined standardized/standardizable segments, taking account of the at least one individual construction-specific input parameter. Not least in the case of implementation for a very specific type of construction, for example for industrial transmission housings of a particular performance class, this gives an information base which is valuable over time or service life that can firstly take account of or give empirical values, but secondly also shows possible variations because of the segmentation or modularization, for example in the case of slight changes to input parameters or application situations that vary according to external conditions.

In one working example, the partly variable construction kit is a digitally integratable construction kit in which the individual parts and optionally also segments and/or modules formed therefrom are runtime-generatable (especially as subassemblies). This also enables, in a simple manner, inclusion of new/additional data or parameters, especially also scaling or extension of the spectrum of construction recommendations generatable in a computer-assisted manner, especially with inclusion of digital tools that use artificial intelligence algorithms or include self-teaching measures implemented in such a way.

In one working example, the partly variable construction kit is a digitally integratable construction kit in which data management or data utilization is effected by means of at least one of the following manual or computer-assisted steps: input of target geometry data; classification of configuration; requesting of existing data and/or comparison with performance data; assignment/allocation of standardized reference parts and variable parts, especially into individual segments and modules; creation or extension or updating of the partly variable construction kit based on a/the frequency distribution of required parts; creation of a digital copy of the welded housing construction; detection/consideration of measurement data of at least one existing/reference component or of at least one existing/reference construction; adjustment of a service factor depending on performance data. This in each case affords an advantageous step in the creation and use of a reliable data/information base with regard to at least one type of construction generatable in a computer-assisted manner.

In one working example, individual segments of the construction are provided in an at least partly design-independent and at least partly build size-independent manner for formation of standardizable/standardized parts of the welded housing construction. This scalability not least also enables use of the construction kit for entirely different (transmission) performance classes.

In one working example, the segments of the construction are (fixed) segments (reference parts or reference part assemblies) that are usable in an at least partly predefined/predefinable manner and optionally also comprise variably/alternatively usable segments. In one working example, the modules are modules usable in a predefined manner and/or modules selectable in a variable manner. The respective configuration of the segmentation/modularization recommended is highly dependent on the individual case and application-specific; it is possible here to define whether the respective segments or modules should also be able to comprise variable parts. An implementation in which all variants can be considered in this regard on the system side can provide and use the broadest information basis.

In one working example, at least one of the variable segments is selected from a catalog of multiple types of that segment in an automated computer-assisted manner, especially on the basis of the at least one individual construction-specific input parameter. The input parameters may also be taken into account within the scope of the selection of parts and/or, in the case of a/the modularization, may also be a boundary condition, depending on possible variations and scope of alternative solutions.

A segment according to the present disclosure especially means a section or region of the overall construction for which a grouping of parts or components leads to a sensible division of the construction. Segmentation can also be effected here, for example, from a functional or material-based point of view. A module according to the present disclosure especially means a grouping of individual parts or segments that are advantageously connectable to one another in one or more manufacturing processes, especially also a grouping that is size-scalable in a simple manner and/or scalable in terms of number for one or more constructions. In this respect, a module may also be characterized by a particular composition or shape of at least one variable segment or multiple variable and fixed segments. It is possible here both for a segment and a module to comprise runtime-generated parts. Multiple modules form, for example, a transmission housing.

For example, lifting lugs or similar external securing means are defined as (fixed) segments usable in a predefined manner that can be used across different designs and in some cases across different construction sizes. For example, terminals for viewing holes or hub strips or wall/side segments or floor strips are defined as variable parts that can be created/assigned in a runtime-generated manner from a digitally integratable base kit (partly variable construction kit system).

It has been found that the construction features that are employed in the case of conventional construction can also be represented and combined in the segments or modules described here in the variable context. It is possible here for the variable parts to be extended continuously, especially in order to take account of new or time-limited existing requirements.

The present invention also enables definition of a functionally coherent standard for the respective application or for the respective construction task, on the basis of which it is possible to activate or deactivate further features, especially with reference to user inputs. Individual segments may be loaded or geometrically varied here in an at least partly automated manner for a selection of features made in each case. This not least also enables efficient handling of a multitude of parts or a wide range of possible variations (especially due to high variability with a simultaneously manageable set of parts).

What is meant here by “runtime-generated” is in particular an operation provided on the system side in which a computer-assisted selection is made from multiple construction alternatives up to and including complete creation of the entire target construction, especially depending on at least one parameter recordable in a user-specific manner. In other words: the term “runtime-generated” here refers in particular to the computer-assisted conversion of the construction object to be generated in each case (especially transmissions or installable parts) proceeding from the input parameters with utilization of a/the data basis available or to be generated for the respective application (partly variable construction kit) to the object utilizable for the planned overall construction. By contrast, the individual components of the planned overall construction would be assembled manually in a conventional construction process, with the need to manually optimize individual parts that do not fit. At the same time, experience has shown that the component matched/altered by design for the individual case is/remains non-reusable, unless exactly the same case of application occurs again. In this respect, a high level of design work was always required in a recurrent manner, even when there are only minimal variances between the individual cases of application; this is because it was necessary to work with the difficulty that the respective specific individual part had to be found among, for example, 5000 versions of similar parts, but this meant a level of search and comparison work that could be higher than a new construction.

The runtime-based generation described here can get around or overcome this difficulty, especially since variable parts can be constantly newly created in a continuous computer-assisted manner on the basis of the respectively most up-to-date current data basis of the construction kit, such that direct current comparison of the individual requirements is possible via the (input and/or optimization) parameters with the existing data, especially in a computer-assisted manner without perceptible search work for the user.

It has been found that the segment design described here with reference to illustrative embodiments can be identified in a comparatively simple manner in view of the hitherto unusual small part size and the associated weld seams. Modules described here can be detected, for example, in hollow profile constructions via a comparison of mass or via a resonance comparison (especially with the aid of a mode hammer).

In one working example, the welded housing construction comprises at least one variable runtime-generated part from the construction kit which is variable in terms of at least one of the following optimization parameters: length, width, material thickness. This consideration of variability not least also enables deeper standardization and integration of base components.

In one working example, at least one of the variable parts or segments or modules of the welded housing construction is runtime-generated from the partly variable construction kit. This step is undertaken especially after selection of parts, or together therewith. The segmentation here may also be a desired segmentation defined at least partly by the user or else a completely computer-generated recommendation of segmentation (which should be confirmed by the user if appropriate before the system effects modularization).

The present invention may especially also be/have been implemented in association with at least one of the following applications:
1 A user inputs application-specific data, for example via a web-based front end, which can initiate runtime-based generation by the process of the invention, and where the user obtains a digital scale model, and where the user is able to assess this outcome subsequently and is able if appropriate to start a new or alternative request; in this respect, data input is required only at the start of the computer-assisted creation of construction.
2 A user wishes to take account of special requirements, for example those that have not yet been taken into account in the provided user interface (especially in the front end); in that case, an administrator or developer can convert these new demands to parameters and distribute a data input over the individual process steps for runtime-based generation; in this connection, new logics or algorithms can be implemented that are then available subsequent to the main application.

In one working example, the method comprises a parameter variation of at least one optimization parameter of at least one variable runtime-generated part of the welded housing construction, especially in the context of an iteration of optimization relating to the welded housing construction that can optionally be selected in a parameter-specific manner by a user, especially relating to material input minimization in the creation of the construction. This not least also enables controlled user interaction, especially also for the purpose of a plausibility test and for discovery of further construction alternatives, especially in a new weighting of the boundary conditions.

Consideration both of input parameters and of optimization parameters also makes it possible to achieve more specific consideration of the terminal fits and performance data that are required in each individual case for the user, where the optimization parameters can be selected or at least suggested on the system side in an application-specific manner for the user or for the construction to be created; this also leads, for example, to a construction not based on an often overdimensioned standard size, but can be regarded as an application-specifically optimized special size.

In one working example, at least one of the modules (or the corresponding subassembly of parts) can be created and/or assigned in an automated computer-assisted manner. It is especially also possible here to refer to individual runtime-generated parts or segments.

In one working example, at least one of the modules forms (or constitutes) a subassembly of parts for a hub strip of the welded housing construction. This specific example shows the potential for savings, especially also for individual assemblies.

In one working example, the modules each form a subassembly, especially a subassembly creatable/assignable in a runtime-generated manner. This mode of modularization not least also enables synergistic coupling with individual manufacturing steps that may need to be considered separately (especially when different manufacturing lines and/or different external service providers are to be/have to be employed for the individual manufacturing processes).

In one working example, individual segments and modules of the welded housing construction have been/are recorded in the construction kit in a predefined relationship/correlation to one another, especially in such a way that the use of a particular segment requires the use/recommendation of a particular module, and/or vice versa. This can also promote further synergistic effects and facilitate further-reaching standardization even in the case of large variations or variances in construction as are frequently experienced.

In one working example, the at least one individualizable construction-specific input parameter of at least part of the welded housing construction is input manually via a graphic user interface or is requested on the part of the system during the computer-assisted creation of the welded housing construction for manual input or variation. This not least also enables a user interaction or influence which is possibly desirable in individual cases, especially for predefined/predefinable decisions or parameters during the construction process.

In one working example, the method comprises at least one of the following steps, especially with observation of the following chronology; input of target geometry data; classification of (transmission) configuration; design of transmission ratio and/or gear set; requesting of existing data; analysis of and/or comparison with performance data, especially adjustment of a service factor; creation of the welded housing geometry based on an assignment/allocation of reference parts (predefined invariable parts) and variable parts (especially alternative or mutually exchangeable parts); creation or extension or updating of a/the partly variable digitally integratable construction kit, especially based on a/the frequency distribution of parts actually required; creation of a digital copy of the welded housing construction; creation/provision of manufacturing documentation; and/or wherein the method is performed on the basis of measurement data from at least one existing/reference transmission, especially by making a comparison with actual performance data, especially in the scope of a computer-assisted iteration. These steps also give advantages with regard to the creation and utilization of a reliable data/information base.

In one working example, a digital copy of the welded housing construction is created and recorded in the database. This not least also extends the space of possibilities of utilization of data or information or results, especially also subsequent to a construction process, for example in association with manufacture or maintenance/overhaul.

The object defined previously further up is also achieved by a method of manufacturing a welded housing, wherein at least one manufacturing system/machine is fed with construction data that are/have been generated and provided by a/the method described previously further up, wherein the manufacturing system/machine is preferably coupled to a/the database (especially via at least one data transfer interface) in which a/the partly variable construction kit used for the generating of the corresponding welded housing construction is recorded. This gives advantages previously mentioned further up. This preferably involves inclusion of the construction data generated from the partly variable construction kit with regard to at least one of the following steps: production of individual (standard) parts/segments; welding production of variable modules; connection/assembly of at least two modules; completion of production of the welded construction.

The object defined previously further up is also achieved by a welded housing construction produced by employment of a/the process described previously further up, wherein the welded housing construction preferably relates to/models a modularized or modularly constructed welded housing in segment design, preferably comprising at least one segment formed from two or more parts and at least one module generated therefrom. This gives advantages mentioned previously further up.

The object defined previously further up is also achieved by a welded housing produced by installing firstly standardized and secondly variable (component) parts that have been selected in an at least partly computer-assisted manner by employing a/the method previously described further up and are/have been constructed or virtually installed collectively in an at least partly computer-assisted manner to form a/the welded housing construction, wherein the welded housing is preferably a modularized welded housing in segment design, preferably comprising at least one segment formed from two or more parts and at least one module generated therefrom. This gives advantages mentioned previously further up, especially also directly in the context of manufacturing.

The object defined previously further up is also achieved by a computer program product comprising commands which, when the computer program product is executed on a computer, cause it to perform a/the method previously described further up on the computer, especially a computer program product set up to convert predefined and variable (component) parts that have been selected/are to be selected in a computer-assisted manner from a/the partly variable construction kit to an at least partly standardized welded construction based on at least one user-/application-specific requirement or a corresponding input parameter, especially with regard to outside dimensions and terminal fits of the construction to be created. This gives advantages mentioned previously further up.

The object defined previously further up is also achieved by use of a partly variable construction kit which is recorded in a database and in which standardized and variable parts are recorded for provision of a welded housing construction generated in an at least partly computer-assisted manner, especially welded housing construction for industrial transmissions, for computer-assisted selection of at least one of the standardized parts and/or at least one of the variable parts with reference to at least one individual/individualizable construction-specific input parameter and for computer-assisted creation of the welded construction by selecting, in a computer-assisted manner, predefined and variable (component) parts from the partly variable construction kit based on at least one user-/application-specific requirement or a corresponding input parameter, especially with regard to outside dimensions and terminal fits of the construction to be created, and converting them, in a computer-assisted manner, to an at least partly standardized welded construction, especially in a method described previously further up. This gives advantages mentioned previously further up.

The object defined previously further up is also achieved by a system set up to execute a method described previously further up, especially with the system comprising: at least one server, at least one database with fixed and variable parts recorded therein, a/the partly variable construction kit, an input mask or user interface for recording of the at least one input parameter (especially geometry data, existing data, performance data).

### BRIEF DESCRIPTION OF THE DRAWINGS

The invention is elucidated in detail hereinafter with reference to the appended drawings using preferred working examples. The word “figure” is abbreviated to “Fig.” in the drawings. It is shown in:

FIGS. 1A, 1B in each case a schematic representation of a perspective side view of a component (hub strip) created according to the prior art on the basis of a construction/manufacturing procedure;

FIG. 2 a schematic representation of a perspective view of an assembly (hub strip with partial thickening and housing sidewall components) created according to the prior art on the basis of a construction/manufacturing procedure;

FIG. 3 a schematic representation of a side view of a housing sidewall designed/constructed on the basis of a construction/manufacturing procedure according to working examples of the invention, especially with reference to predefined/predefinable segments and modules;

FIG. 4 a schematic diagram of a reference of the construction/manufacturing procedure of the invention to individual manufacturing steps and modules created therewith;

FIGS. 5A, 5B in each case a schematic representation of a perspective side view or section view of a component (hub strip) based on a construction/manufacturing procedure of the invention;

FIG. 6 a schematic representation of individual steps of a method according to working examples of the invention, especially in an implementation in association with at least one manufacturing process;

FIG. 7 a schematic representation of individual interacting components in the execution of the present invention according to working examples;

FIGS. 8A, 88, 8C, 8D, 8E, 8F in each case a schematic representation of a perspective side view of a welded component or a welded construction creatable by means of a construction/manufacturing procedure of the invention;

FIGS. 9A, 9B, 9C, 9D, 9E, 9F, 9G, 9H in each case in pairs, in a schematic diagram and perspective view, four examples of computer-assisted optimization approaches based on an implementation of the present invention.

### DETAILED DESCRIPTION OF THE WORKING EXAMPLES

The working examples described are merely examples that can be modified and/or supplemented in various ways within the scope of the claims. Any feature which is described for a particular working example can be utilized in any other working example independently or in combination with any other features. Any feature which is described for a working example of a particular claim category can also be used correspondingly in a working example of a different claim category. Reference numerals are first described in general terms; an individual reference is made in connection with the respective figure description. The reference numeral 100 is used here synonymously both for a welded (housing) construction (or the corresponding construction data and the computer-assisted image thereof) and for a/the welded housing producible on the basis thereof or similar complex finally mounted/welded component group.

A welded housing 1, especially for industrial transmissions, has, for example, individual side walls 1.1 that can be provided by sidewall assemblies 1.3, where these may comprise, for example, the following parts: lifting lugs 3, especially first lifting lug 3a (left) and second lifting lug 3b (right/opposite); connection 5, especially for a viewing hole; hub strip 7 (of conventional design); further sidewall component 8, especially in the lower edge region of the side wall assembly 1.3; foot/floor strip 9.

A conventional procedure for construction/manufacture of the hub strip 7 gives rise to a comparatively high (proportion of) offcut material 7a. By means of the partly variable construction kit 10 described in detail hereinafter, the construction procedure and the associated solution generated with computer assistance (suggested construction) can lead to a perceptible reduction in material and/or energy expenditure.

The partly variable construction kit 10 is based firstly on fixedly predefined parts 11 (non-variable) and secondly also on variable parts 12; in the context of the present invention, segments 13 and modules 14 can be generated therefrom in a computer-assisted manner, especially configured as construction-specific subassemblies. This computer-assisted determination of the individual constructions that are advisable in their respective individual case, but also those that are based as far as possible at least partly on standardized material-/energy-optimized parts, is described here with particular reference to a/the hub strip 17 (especially comprising/composed of variable parts), in which, due to the procedure of the invention, a (proportion) of offcut material 17a is perceptibly minimized.

The method of the invention can be implemented here with consideration of at least one input parameter p and with utilization of at least one server 20 and at least one data memory 21 (or database), and with involvement of a computer program (or product) 30, where user interaction at various stages of the creation of construction is enabled via a graphic user interface 31. Implementation can be effected here optionally with involvement of a manufacturing line 40 (or the manufacturing processes implementable therewith) with, for example, a first, second, third and fourth manufacturing system/machine 41, 42, 43, 44. In this way, using a high proportion of standardized components (or, as the case may be, also exclusively), it is nevertheless possible to arrive at individualized welded housing constructions 100, especially transmission housing constructions. The data (sets) generated and utilized can also be provided directly or subsequently for downstream (manufacturing) processes or for supervision of the respective plant throughout its lifetime.

The present invention may especially be/have been implemented in association with the following steps: S1 input of target geometry data; S2 classification of (transmission) configuration; S3 design of transmission ratio and/or gear set; S4 requesting of existing data; S5 comparison with performance data; S6 creation of the welded housing geometry based on assignment/allocation of reference parts and variable parts; S7 creation or extension or updating of a/the partly variable digitally integratable construction kit, especially based on a/the frequency distribution of parts actually required; S8 creation of a digital copy of the welded housing construction; S9 creation/provision of manufacturing documents; S10 recording/consideration of measurement data of at least one existing/reference transmission (especially comprising step S10a); S10a analysis/comparison with actual performance data, especially adjustment of a service factor.

It is possible here for there to be at least partially automated transformation S100 of individual selected components/component groups to a welded housing construction 100 generated in an at least partly computer-assisted manner. There may optionally also be couplings here to at least one of the following manufacturing processes: S200 production of individual (standard) parts/segments; S300 welding production of variable modules; S400 connection or assembly of at least two modules; S500 completion of production of the welded housing.

There follows a discussion of respective individual aspects of the working examples shown in the figures

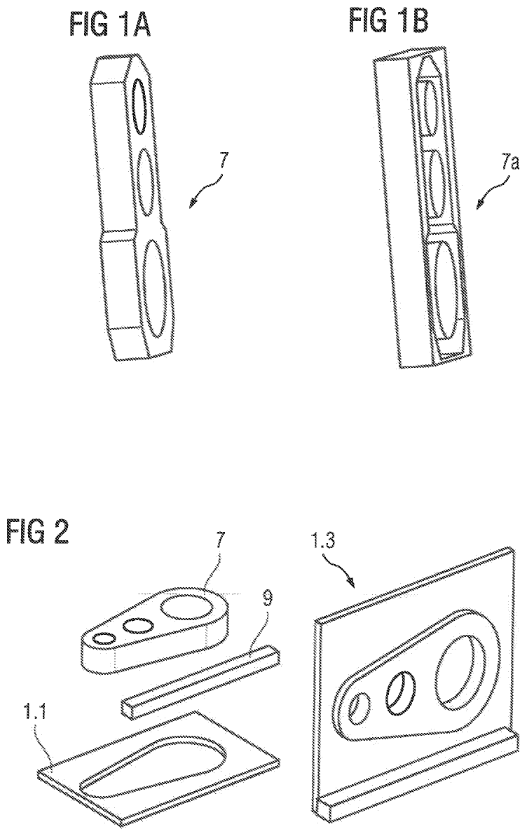

FIGS. 1A, 1B illustrate an example of existing (disadvantageous or uneconomic and/or optimizable in terms of energy/emissions) material use, especially with reference to a hub strip (receptacle for bearing systems). It is typically necessary for the hub strip to be cut out of the side wall, especially in the monoblock region. This is, for example, a sheet of thickness 10-40 mm. This construction/manufacturing procedure is accordingly associated with a considerable level of offcuts. FIG. 1A shows the hub strip. FIG. 1B shows the proportion of offcuts.

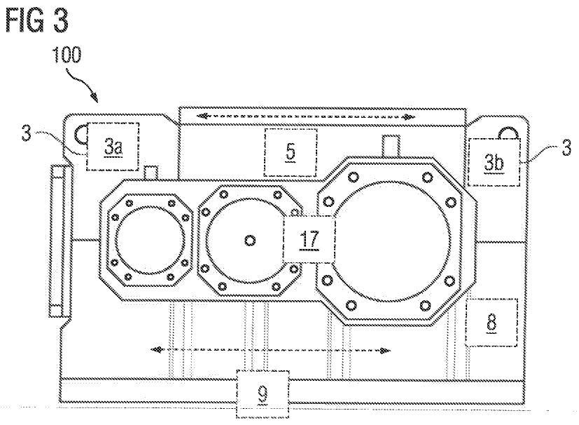

FIG. 2 illustrates existing approaches for optimization of a construction, for which reference is made to the components of a side wall of a (transmission) housing, although these approaches have to date also been pursued for many other applications/constructions. Low steel prices at times and processing methods that were already comparatively efficient possibly only gave little reason to date to put any great effort into offcut-optimized constructions. In particular, there has to date been partial thickening or material strengthening in the respectively required section of the construction, here by way of example of a/the hub strip, especially in order to be able to reduce the minimum sheet thickness. For instance, even in the case of a driveshaft (especially a slow-running driveshaft), a further piece of sheet metal is welded on in order to be able to perceptibly reduce the overall thickness of the rest of the hub strip. Apart from that, the construction is designed in particular according to the provision of having to implement as few as possible individual parts, especially in order to minimize manual work. FIG. 2 illustrates a section contour based on this procedure to date for a side wall of a (transmission) housing, where this sidewall assembly 1.3 which is implementable in particular in duplicate on opposite sides of the housing is/has been formed from three components: side wall 1.1, hub strip 7, foot/floor strip 9. However, this procedure in many applications leads to a disadvantageously high proportion of offcuts and hence also distinctly higher energy consumption or CO2 consumption.

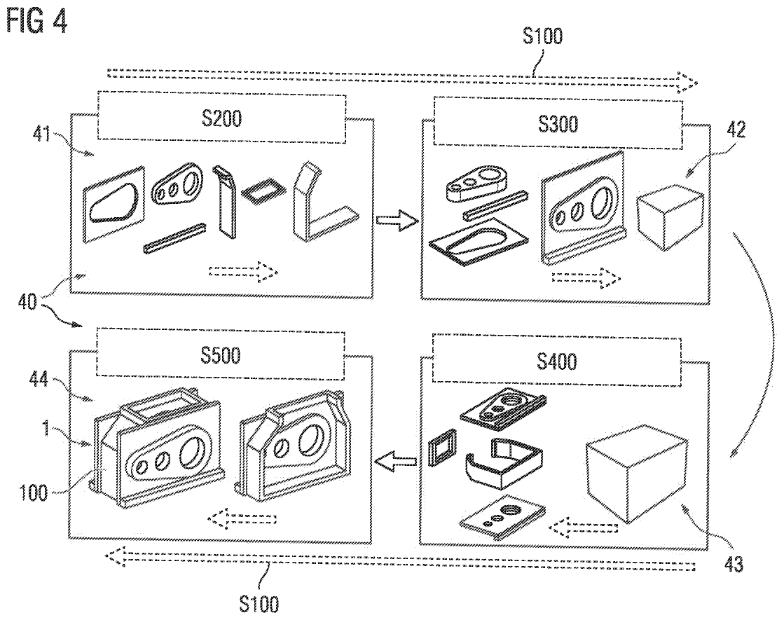

The invention also makes it possible, for example, to transform various user-specific demands with regard to outside dimensions and terminal fits in an at least partly automated manner to a welded construction, especially in an at least partly computer-assisted manner with involvement of a partly variable construction kit that can be maintained firstly in an at least partly computer-assisted manner (data management, updating, inclusion of new boundary conditions), and can secondly also be used in an at least partly computer-assisted manner for the creation of the construction or individual components of the final overall construction, where implementation may also be effected directly in association with individual manufacturing lines/steps, especially in order to be able to take account of special features of individual manufacturing lines or materials or processing/material working steps (for example peculiarities in the welding of particular materials or material combinations/pairs). There is preferably also division of the (welded) construction to be created into segments and modules that can be assigned to or taken from a partly variable construction kit system (FIG. 3).

With reference to FIG. 3, one aspect of the inventive creation of the target construction is elucidated, which enables standardization with still maximum flexibility of variation, again with reference to a housing sidewall assembly. In this context, the parts 3 (or parts 3a, 3b on opposite sides of the assembly shown in FIG. 3) form fixed segments (or are defined as such in the context of the present invention), where these segments can be used in a design-independent and at least partly build size-dependent manner. By contrast, the parts 5 (terminal viewing hole diameter), 8 (wall component/assembly), 9 (foot/floor strip or floor assembly) and 17 (hub strip) each form variable (groups of) parts that can be generated from the construction kit described here (especially configured as a digitally integratable standard base kit), especially in an at least partly computer-assisted manner. In other words: the construction is no longer created (solely) on the basis of the individual parts employed to date, but can also be optimized by combination of advantageous segments and modules, especially with regard to material and energy use; this firstly permits great variability, and secondly also standardization and hence also scale/synergy effects, especially in the case of direct coupling with the respectively relevant manufacturing process or that which is achievable according to the technological fitout of a particular company (machine part manufacturing lines, inside/outside manufacture or similar aspects). The respective dotted double arrow illustrates by way of example a spatial or functional extent of an individual segment.

It is possible for runtime-generated parts to vary both in length and width, and in material thickness. Depending on the specifically definable input parameters, a/the algorithm implementable in the context of the present invention can also be used to decide the variable segment to be used (computer-assisted selection based on application-specifically definable boundary conditions. For example, part 5 (wall component/assembly) may either be a flat side wall or a variant with irregular load-adapted bulges (especially in the form of a bulkhead design) or else incorporate/have other functional/construction features. A/the inventive division of the variable and fixed segments described here by way of example specifically enables, with reference to the housing sidewall described here, a distinct reduction in the amount of offcuts, especially for the hub strip, and accordingly also a noticeable reduction in the CO2 equivalent of the manufacturing required for the purpose (comparable benefits from an energy point of view especially in the case of metallic materials).

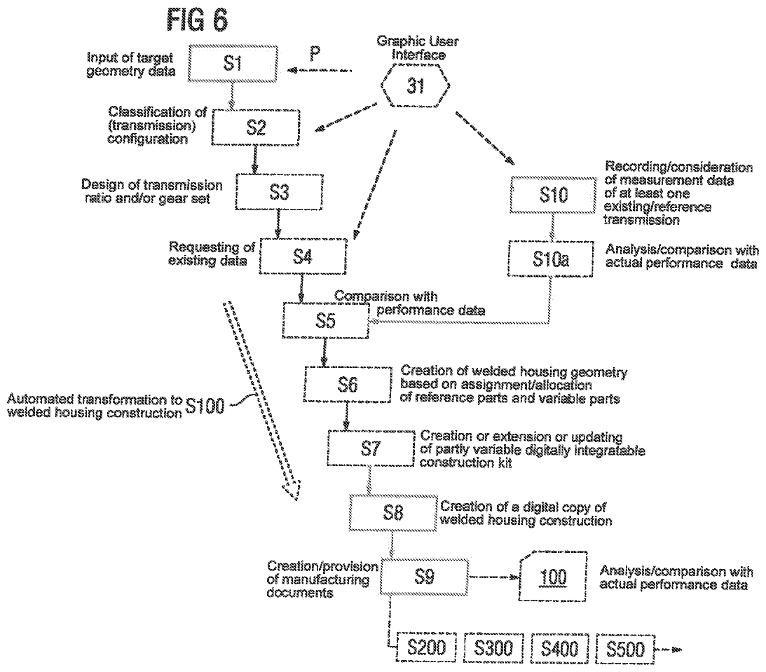

The modules described here may be subassemblies that can likewise be created by the implementable algorithm and/or assigned in a runtime-generated manner. The hub strip is cited here once again as an example. In the case of small component sizes, this can especially be assigned to the construction kit as a variable segment or as consisting of fixed parts, or, in the case of larger built sizes, may especially consist of dedicated variable and fixed segments (compare with FIG. 2, FIGS. 5A, 5B). It is possible to take account of different construction requirements and degrees of detail and construction phases in a computer-assisted manner. For example, the concept of hollow profile construction can be employed or taken into account in a computer-assisted manner in the selection and definition of the individual parts/segments/modules, especially in order to achieve similar mechanical properties to those in the case of a solid part (optionally input parameters relating to stiffness or similar material parameters).

In the example considered here, it is possible to reduce the amount of offcut material in accordance with the invention to the two outer sheets, while the intermediate pieces of semifinished products can be cut to length. The receiving of the shaft bearings can be enabled, for example, by means of semifinished tubular products. The constructor can also subject the construction components generated in an at least partially computer-assisted manner to occasional comparison checks and, if appropriate, initiate the generation of further alternatives, for example with different weighting of individual input parameters.

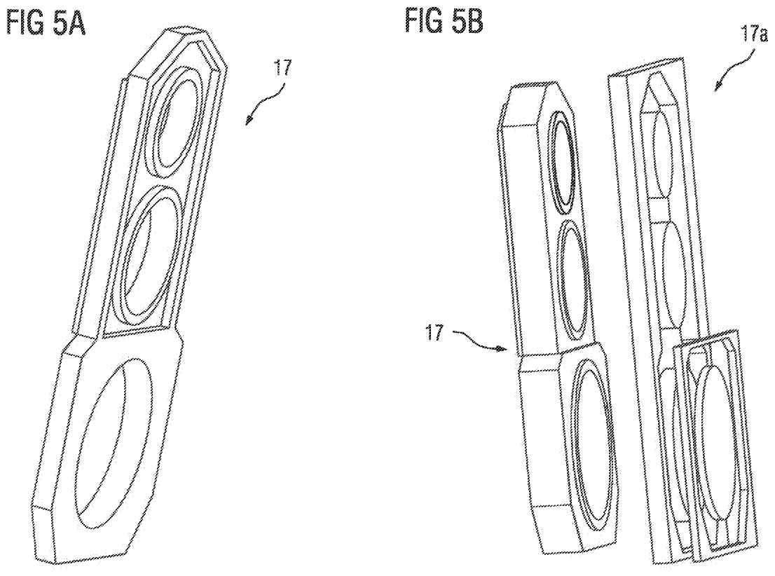

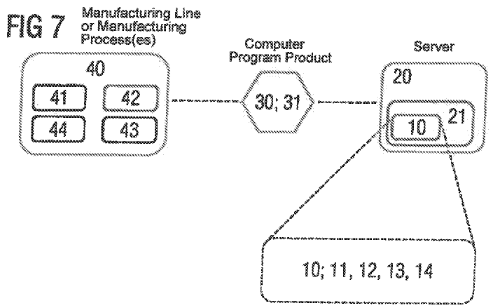

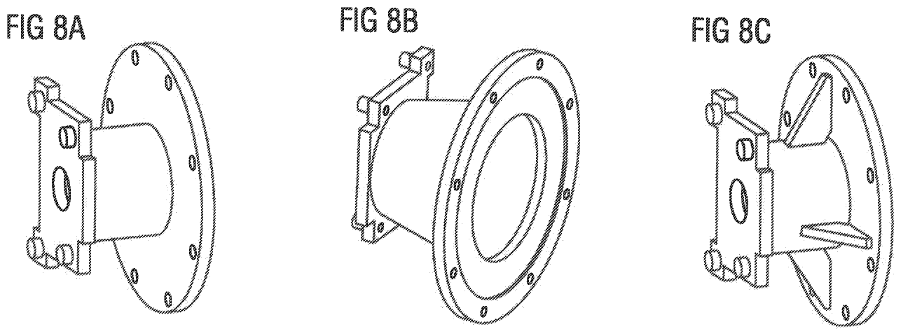

FIG. 4 elucidates an interaction of the inventive at least partly automated transformation (step S100) of boundary conditions and individual parts into a (preferably modularized, segmented) welded housing construction generated in a computer-assisted manner with actual manufacturing steps: step S200 relates to the production of individual (standard) parts/segments, especially here, by way of example, plasma cutting and autogenous welding by a manufacturing unit/line (machining process unit); step S300 relates to welding production of variable modules, for example with inclusion of instant robot programming system (IRPS) technology, for example in a single welding machine (compact welding unit); step S400 relates to the connection/combining of at least two modules, for example by means of a portal welding system, especially with inclusion of off-line programming; step S500 relates to a/the final completion of production of the welded housing, especially by welding the outlines of the housing or of the individual modules to one another, whether manually or at least partly assisted by a welding robot. The at least partly automated transformation described here (step S100) can accompany the individual manufacturing steps or take account of input parameters or boundary conditions in this regard. A/the respective usable manufacturing machine (or a corresponding section of a manufacturing line) is illustrated here in each case by a block arrow with a dotted line (dotted outline). The steps employed for computer-assisted creation of the construction, by contrast, are illustrated by dashed lines (the same differentiation is also made in the illustration in FIG. 6), where these steps may be undertaken so as to accompany the manufacture or completely independently in terms of time, which is illustrated by the dashed block arrow S100.

FIGS. 5 show different configurations of the hub strip. 17. FIG. 5A shows, in particular by comparison with FIG. 1, a hub strip, the production of which was based on comparatively thin semifinished products (maximum reduction in offcut material), whether for reasons of material saving or because sufficiently thick material (especially sheet metal) was unavailable. The hub strip shown is formed from individual segments. In this context, regions subject to zero or less stress are replaced at least partly by cavities, which can save weight and offcut material. FIG. 5A shows a section through the hub strip also shown in FIG. 5B, which makes the cavities incorporated by construction/taken into account apparent. FIG. 5B shows both a specific working example of the hub strip 17 and the corresponding proportion of offcut material 17a. Especially by comparison with the proportion of offcut material shown in FIG. 1B (prior art), this proportion of offcut material is comparatively small.

The segment design described here also enables much further-reaching digitalization and hence also standardization of the production process(es) for welding products in general (here as described in particular with reference to comparatively complex transmission housings), where the production/manufacture can optionally also be effected with reference to a/the digital copy of the construction.

Subsequently, the inventive procedure for the creation of the construction (step S100) can also be effected by reference to an illustrative procedure of individual steps specifically for a specific welded housing construction, with optional variation in the sequence and/or combination of individual steps in the specific individual case after implementation of the partly variable digital construction kit described here: step S1 input target data of the target geometry; step S2 sorting by classes of configuration; step S3 design gear set (or, by way of example, another component in the construction) in accordance with the geometric data as limiting parameter; step S4 request existing data (search for repetitions), where existing data in particular also relate to data from systems that are already built or in use, especially transmissions; step S5 compare performance data (optimization), where performance data especially also relate to the operating parameters, for example, of a transmission or another system for which the construction is generated; (at this point in particular, step S10 or S10a can also be effected, mainly detection/consideration of measurement data of an existing/reference transmission, and/or a comparison with actual performance data, especially adjustment of a service factor); step S6 creation of the housing geometry, especially by assignment of reference parts (fixed parts) and variable parts; step S7 creation of a/the variable construction kit, for example based on the frequency distribution of parts actually required (especially for the purpose of company-/industry-specific individual matching to market needs); step S8 creation of a digital copy (especially with regard to digitally supported service and replacement part measures); S9 creating the manufacturing documents, especially at a (communicative) interface to a/the corresponding manufacturing line/unit.

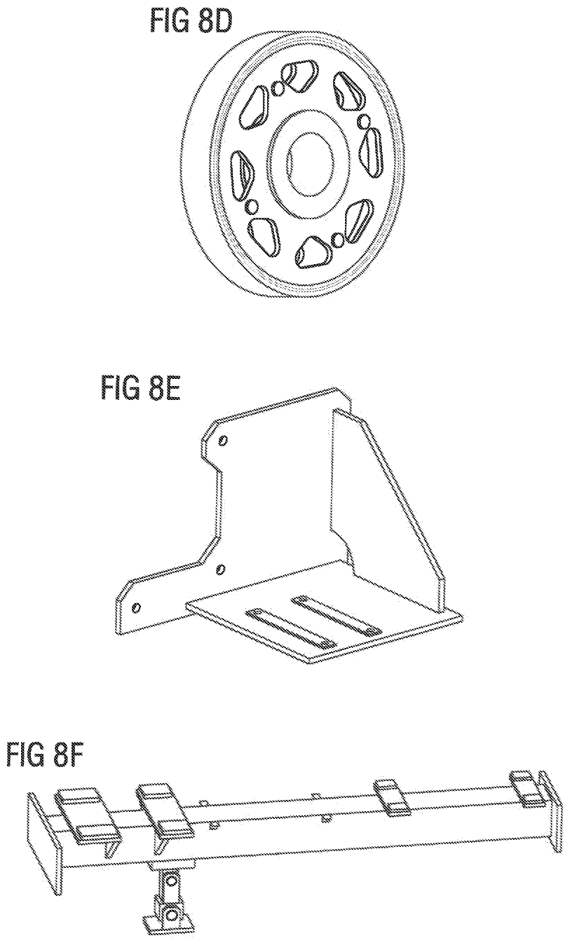

FIGS. 8A, 8B, 8C, 8D, 8E, 8F show, by way of example, further weld constructions for which the present invention is implementable, namely: standard cylinder with flange at both ends and optionally also fin support (FIG. 8A, FIG. 8C), cone with flange at both ends (FIG. 8B), welded gear (FIG. 8D), brake console (FIG. 8E), swing arm (FIG. 8F).

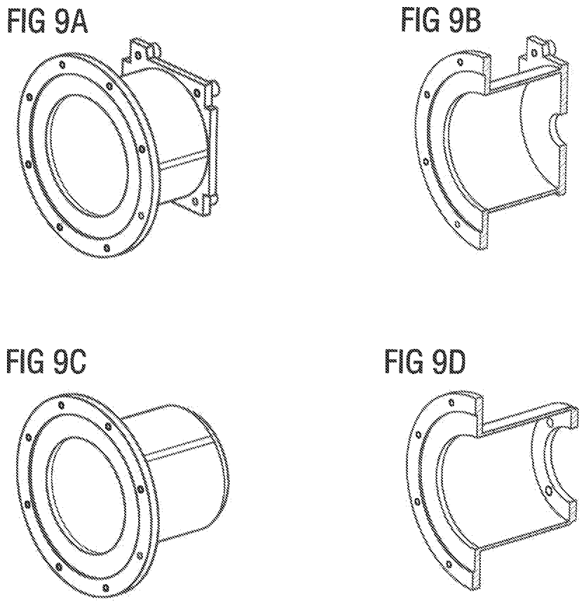

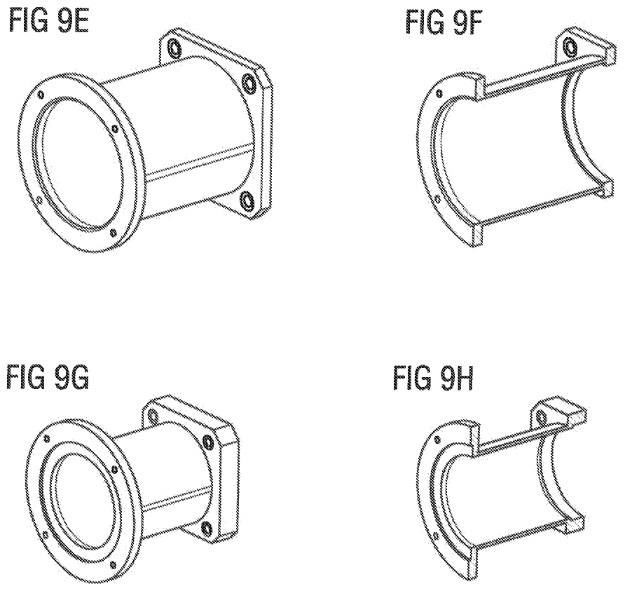

FIGS. 9A, 9B, and 9C, 9D and 9E, 9F and 9G, 9H illustrate, in pairs, four examples of optimization approaches based on the present invention, each with reference to one specific construction approach among several in the respective application or a standard cylinder with a flange at both ends: FIGS. 9A, 9B show a first optimization approach, where the component is/has been optimized with regard to material input and weight; FIGS. 9C, 9D show a second optimization approach, where the component is/has been optimized, for example, with regard to the configuration or integration of at least one of the flanges; FIGS. 9E, 9F show a third optimization approach, where the component is/has been optimized, for example, with regard to the configuration of the terminal diameter or at least one flange provided for the purpose (especially terminal binding of the flange); FIGS. 9G, 9H show a fourth optimization approach, where the component is/has been optimized, for example, with regard to the binding of at least one of the flanges to the cylinder (here in particular also variation with regard to internal centering of the cylinder in the flange). It is optionally possible in these individual optimizations or multiple iterations also to consider at least one particular available manufacturing/welding method, as already elucidated further up.

### List of Reference Numerals

1 welded housing (construction), especially for transmissions
1.1 side wall
1.3 sidewall assembly
3 lifting lug (especially predefined part/segment)
3a, 3b first lifting lug, second lifting lug
5 connection of viewing hole diameter (in particular variable part(s))
7 hub strip as per conventional design
7a offcut material as per conventional design
8 wall component/assembly (in particular variable parts/segments)
9 foot/floor strip or floor assembly (in particular variable parts/segments)
10 partly variable construction kit
11 fixedly predefined part (not variable)
12 variable part
13 segment
14 module
17 hub strip (especially with/composed of variable parts)
17a offcut material
20 server with logic/computation unit (in particular CPU)
21 data memory, database
30 computer program product
31 graphic user interface
40 manufacturing line or manufacturing process(es)
41 first manufacturing system/machine
42 second manufacturing system/machine
43 third manufacturing system/machine
44 fourth manufacturing system/machine
100 welded housing (construction), especially transmission housing (construction)
P input parameter
S1 input of target geometry data
S2 classification of (transmission) configuration
S3 design of transmission ratio and/or gear set
S4 request for existing data
S5 comparison with performance data
S6 creation of the welded housing geometry based on an assignment/allocation of reference parts and variable parts
S7 creation or extension or updating of a/the partly variable digitally integratable construction kit, especially based on a/the frequency distribution of parts actually required
S8 creation of a digital copy of the welded housing construction
S9 creation/provision of manufacturing documents
S10 creation/consideration of measurement data of at least one existing/reference transmission, especially comprising step S10a
S10a analysis/comparison with actual performance data, especially adjustment of a service factor
S100 automated transformation to welded housing construction generated with computer assistance
S200 production of individual (standard) parts/segments
S300 welding production of variable modules
S400 connection/assembly of at least two modules
S500 completion of production of the welded housing

1.-23. (canceled)

24. A method of providing a welded construction generated in an at least partly computer-assisted manner, especially a welded housing construction for industrial transmissions, the method comprising;
defining manually or with computer assistance of at least part of the welded construction an individual construction-specific input parameter selected from a group consisting of build size parameter, terminal fit parameter, and build shape parameter;
resorting for the at least partly computer-assisted definition of the welded construction to a database having recorded therein a partly variable construction kit in which at least two standardized parts are recorded, with one of the at least two standardized parts being selected in a computer-assisted manner to form the welded construction;
generating the welded construction in a computer-assisted manner using the selected one of the at least two standardized parts and taking into account the individual construction-specific input parameter; or
generating the welded construction in a computer-assisted manner based on the selected one of the at least two standardized parts and based on at least one of several variable parts recorded in the partly variable construction kit.

25. The method of claim 24, wherein the individual construction-specific input parameter is at least one of the terminal fit parameter and the build size parameter for generating the welded construction.

26. The method of claim 24, further comprising:
dividing the welded construction into predefined segments and into modules, or dividing at least one of the at least two standardized parts and the variable parts into predefined segments and into modules; and
selecting for the welded construction at least one of the segments and at least one of the modules,
wherein the computer-assisted definition/generation of the welded construction involves reference to the database with the partly variable construction kit in which the segments and modules are recorded and from which the segments and modules suitable for the welded construction are selected in a computer-assisted manner, and
wherein the welded construction is generated from the construction kit in the case of at least partial standardization by inclusion of at least one of the predefined standardized segments and taking into account of the individual construction-specific input parameter.

27. The method of claim 26, wherein the partly variable construction kit is a digitally integratable construction kit in which the at least two standardized parts and the variable parts and optionally also segments and/or modules formed therefrom are runtime-generated.

28. The method of claim 24, wherein the partly variable construction kit is a digitally integratable construction kit in which data management or data utilization is effected by at least one of manual or computer-assisted steps selected from the group consisting of input of target geometry data; classification of configuration; requesting of existing data and/or comparison with performance data; assignment/allocation of standardized reference parts and variable parts, especially into individual ones of the segments and modules; creation or extension or updating of the partly variable construction kit, especially based on a frequency distribution of required parts; creation of a digital copy of the welded construction, detection/consideration of measurement data of an existing/reference component and/or of an existing/reference construction, and adjustment of a service factor depending on performance data.

29. The method of claim 26, wherein individual ones of the segments of the welded construction are provided at least partly independently of design and at least partly independently of build size for formation of the at least two standardized parts or groups of parts of the welded construction.

30. The method of claim 26, wherein individual ones of the segments of the welded construction are segments usable in an at least partly predefined manner and optionally also include variably/alternatively usable segments.

31. The method of claim 26, wherein at least one of the segments of the welded construction is selected from a catalogue of multiple types of the at least one of the segments in an automated computer-assisted manner, especially based on the individual construction-specific input parameter.

32. The method of claim 26, wherein the modules of the welded construction are modules usable in a predefined manner and/or variably selectable modules.

33. The method of claim 24, wherein the welded construction comprises from the construction kit a variable runtime-generated part which is variable in terms of at least one of optimization parameters selected from the group consisting of length, width, and material thickness.

34. The method of claim 26, wherein at least one of the variable parts or segments or modules of the welded construction is runtime-generated from the partly variable construction kit.

35. The method of claim 24, further comprising a variation of parameters in an optimization parameter of a variable runtime-generated part of the welded construction, especially in a context of an iteration of optimization relating to the welded construction that can optionally be selected in a parameter-specific manner by a user, especially relating to material input minimization.

36. The method of claim 26, further comprising creating and/or assigning at least one the modules of the welded construction in an automated computer-assisted manner.

37. The method of claim 26, wherein at least one of the modules forms/constitutes a subassembly of parts for a hub strip of the welded construction.

38. The method of claim 26, wherein the modules each form a subassembly, especially a subassembly which is creatable/assignable in a runtime-generated manner.

39. The method of claim 26, wherein individual ones of the segments and modules of the welded construction are recorded in the construction kit in a predefined relationship/correlation to one another, especially in such a way that a use of a particular one of the segments requires a use/recommendation of at least one particular one of the modules, and/or vice versa.

40. The method of claim 24, further comprising manually inputting the individual construction-specific input parameter of at least one of the at least two standardized parts and variable parts of the welded construction via a graphic user interface or querying on a system side during the computer-assisted creation of the welded construction for manual input or variation.

41. The method of claim 24, further comprising:
creating a digital copy of the welded construction; and
recording the digital copy in the database.

42. A method of manufacturing a welded housing; the method comprising:
recording a partly variable construction kit in a database;
generating construction data from the partly variable construction kit by the method set forth in claim 24; and
feeding the construction data to a manufacturing system or manufacturing machine coupled to the database for generating a corresponding welded construction.

43. A welded construction, especially welded housing construction, produced by the method set forth in claim 24, the welded construction comprising:
a modularized or modularly constructed welded housing in segment design;
a segment formed from two or more parts; and
a module generated from the segment.

44. A welded housing, produced by installing standardized parts and variable (component) parts that have been selected in a computer-assisted manner by employing the method set forth in claim 24 and constructed collectively in a computer-assisted manner to form a corresponding welded construction, wherein the welded housing is a modularized welded housing in segment design, the welded housing comprising:
a segment formed from two or more parts; and
a module generated from the segment.

45. A non-transitory computer program product comprising commands which, when the computer program product is executed on a computer, cause the computer to perform the method set forth in claim 24, the computer program product designed to convert predefined standardized parts and variable (component) parts that have been selected in a computer-assisted manner from a variable construction kit to an at least partly standardized welded construction based on a user-specific application or application-specific requirement or a corresponding input parameter, especially with regard to outside dimensions and terminal fits of the welded construction to be created.

46. A partly variable construction kit recorded in a database, the partly variable construction kit comprising standardized parts and variable (component) parts designed
for provision of a welded construction generated in an at least partly computer-assisted manner, especially welded housing construction for industrial transmissions,
for computer-assisted selection of at least one of the standardized parts and/or at least one of the variable parts with reference to an individual construction-specific input parameter, and
for computer-assisted creation of the welded construction by selecting, in a computer-assisted manner, predefined ones of the standardized and variable parts from the partly variable construction kit based on a user-specific requirement or application-specific requirement or a corresponding input parameter, especially with regard to outside dimensions and terminal fits of the construction to be created, and converting the predefined ones of the standardized and ones of the variable parts in a computer-assisted manner to an at least partly standardized welded construction, especially in the method set forth in claim 24.
